(19) United States
(12) Patent Application Publication
(10) Pub. No.: US 2020/0401739 A1
(43) Pub. Date: Dec. 24, 2020

(54) Modeling Fracture Closure Processes In Hydraulic Fracturing Simulators

(71) Applicant: Halliburton Energy Services, Inc., Houston, TX (US)

(72) Inventors: Jie Bai, Katy, TX (US); Dinesh Ananda Shetty, Sugarland, TX (US); Baidurja Ray, Houston, TX (US); Jianfu Ma, Pearland, TX (US)

(73) Assignee: Halliburton Energy Services, Inc., Houston, TX (US)

(21) Appl. No.: 16/901,464

(22) PCT Filed: Jan. 16, 2018
(86) PCT No.: PCT/US2018/013859

§ 371 Date: Jun. 15, 2020

(51) Int. Cl. G06F 30/20; E21B 43/267

(52) U.S. Cl. CPC G06F 30/20; G06F 2111/04; E21B 2200/20; E21B 43/267

(57) ABSTRACT

A method and system for modeling a fracture in a hydraulic fracturing simulator. The method may comprise simulating a well system with an information handling system, defining a closure criteria for a hydraulic fracturing operation, assembling at least one variable in a linear system, assembling at least one variable of a contact force in the linear system, solving for the contact force, and determining at least one opening or at least one closing of the fracture with the contact force. The system may comprise a processor and a memory coupled to the processor. The memory may store a program configured to simulate a well system with an information handling system, define a closure criteria for a hydraulic fracturing operation, assemble at least one variable in a linear system, and determine at least one opening or at least one closing of the fracture with the contact force.

### BACKGROUND

Wellbores drilled into subterranean formations may enable recovery of desirable fluids (e.g., hydrocarbons) using a number of different techniques. Stimulation of the wellbore may be a technique utilized to enable and/or improve recovery of desirable fluids. During stimulation treatment, fluids may be pumped under high pressure into a rock formation through a wellbore to fracture the formation and increase permeability, which may enhance hydrocarbon production from the formation. Stimulation operations may be expensive and time consuming. As there may be many different techniques, material, and tools available, stimulation operators may try to determine the techniques, material, and tools that may be more effective in a formation.

Operators may utilize numerical simulators to simulate stimulation treatment before the stimulation operations may be put into place. Such simulators may be identified as hydraulic fracturing simulators. Many existing simulators may simulate fracture propagation within a stimulation operation. However, many existing simulators remove the fracture from the simulator once they have closed, and may satisfy the closure criteria only approximately. Thus, existing simulators may be unable to capture multiple-fracture opening and closing as is probable in actual treatments, while also being unable to satisfy the necessary closure criteria exactly. Additionally, existing simulators may also be unable to capture the effect of the stress on closed conductive fractures.

### BRIEF DESCRIPTION OF THE DRAWINGS

For a detailed description of the preferred embodiments of the invention, reference will now be made to the accompanying drawings in which:

FIG. 1 illustrates a schematic view of an example well system utilized for hydraulic fracturing;

FIG. 2 illustrates a flow chart for a hydraulic fracturing simulator;

FIG. 3 illustrates a flow chart for adding a contact force to the hydraulic fracturing simulator;

FIG. 4 illustrates a fracture and a width of a closed fracture;

FIGS. 5A-5C illustrate proppant disposed in a fracture; and

FIG. 6 illustrates a flow chart of different closure criteria.

### DETAILED DESCRIPTION OF THE PREFERRED EMBODIMENTS

The present disclosure describes methods and systems to account for—fracture closure processes with and without proppant, in stimulation simulators. In a stimulation simulator, the solid mechanics of a subterranean rock formation may be identified, the fluid mechanics of slurry flow through fractures in the rock may be identified, and/or the dynamics of proppants in the slurry may be identified. In a stimulation operation, as well as the simulator, when slurry is not pumped through the fractures in a formation, the fractures tend to close due to stresses in formation. As the faces of fracture close on each other and come into contact, they experience a contact force that may prevent them from penetrating into each other. As disclosed, a method may be utilized for determining contact force in a fully coupled hydraulic fracturing simulator. In examples, the unknown variables in a hydraulic fracturing simulator (commonly rock displacements or stresses, pore pressure, fracture height, fluid pressure, proppant concentration, etc.) may be coupled and/or decoupled in some manner. Furthermore, as disclosed below, the simulator may also include cases where the variables may be coupled implicitly and/or explicitly.

The methods and system disclosed below may ensure zero penetration between fracture faces at all times, and allowing for any number of re-openings and closings of a fracture. Factors for ensuring zero penetration may include unpropped fracture closure on itself leading to a residual conductivity that may be a function of fracture face roughness, rock stresses, fluid pressure etc., fracture closure on proppant size, closure on a fully packed proppant bed, closure on a fracture that is partially filled with packed settled proppant bed and partially filled with proppant-laden slurry, and/or the type of proppant embedment in a fracture.

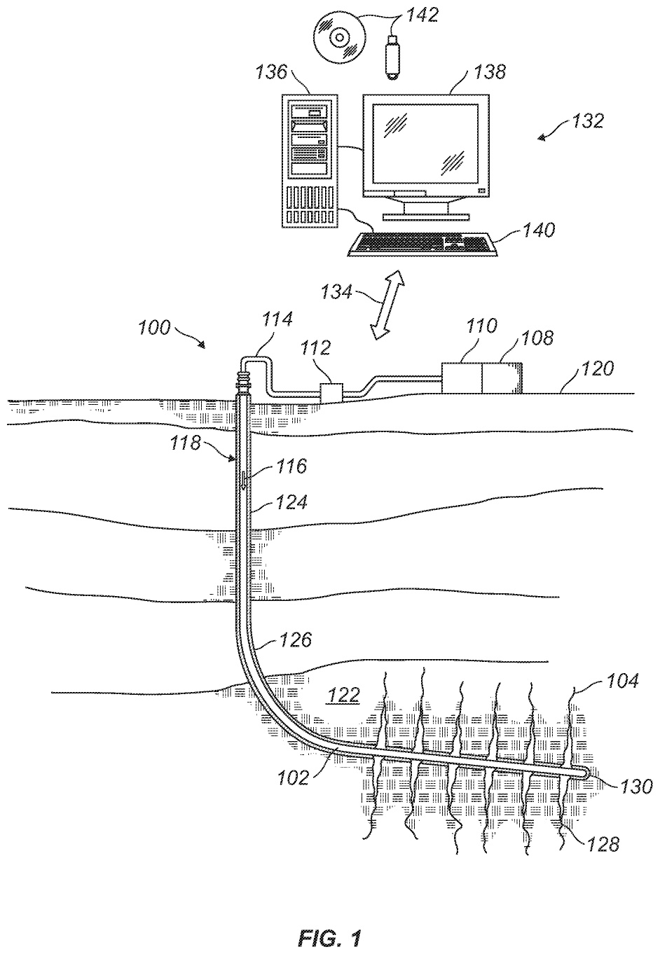

FIG. 1 illustrates an example of a well system 100 that may be used to introduce proppant 102 into fractures 104. By way of example, the well system 100 may be simulated in a hydraulic fracturing simulator. The well system 100 may include a fluid handling system 106, which may include fluid supply 108, mixing equipment 110, pumping equipment 112, and wellbore supply conduit 114. Pumping equipment 112 may be fluidly coupled with the fluid supply 108 and wellbore supply conduit 114 to communicate a fracturing fluid 116, which may comprise proppant 102 into wellbore 118. The fluid supply 108 and pumping equipment 112 may be above the surface 120 while the wellbore 118 is below the surface 120.

Sell system 100 may also be used for the injection of a pad or pre-pad fluid into the subterranean formation at an injection rate at or above the fracture gradient to create at least one fracture 104 in subterranean formation 122. The well system 100 may then inject the fracturing fluid 116 into subterranean formation 122 surrounding the wellbore 118. Generally, a wellbore 118 may include horizontal, vertical, slanted, curved, and other types of wellbore geometries and orientations, and the proppant 102 may generally be applied to subterranean formation 122 surrounding; any portion of wellbore 118, including fractures 104. Wellbore 118 may include casing 124 that may be cemented (or otherwise secured) to the wall of wellbore 118 by cement sheath 126. Perforations 128 may allow communication between wellbore 118 and subterranean formation 122. As illustrated, perforations 128 may penetrate casing 124 and cement sheath 126 allowing communication between interior of casing 124 and fractures 104. A plug 130, which may be any type of plug for oilfield applications (e.g., bridge plug), may be disposed in wellbore 118 below perforations 128.

In accordance with systems and/or methods of the present disclosure, a perforated interval of interest (depth interval of wellbore 118 including perforations 128) may be isolated with plug 130. A pad or pre-pad fluid may be injected into the subterranean formation 122 at an injection rate at or above the fracture gradient to create at least one fracture 104 in subterranean formation 122. Then, proppant 102 may be mixed with an aqueous based fluid via mixing equipment 110, thereby forming a fracturing fluid 116, and then may be pumped via pumping equipment 112 from fluid supply 108 down the interior of casing 124 and into subterranean formation 122 at or above a fracture gradient of the subterranean formation 122. Pumping the fracturing fluid 116 at or above the fracture gradient of the subsurface formation 122 may create (or enhance) at least one fracture (e.g., fractures 104) extending from the perforations 128 into the subterranean formation 122. Alternatively, fracturing fluid 116 may be pumped down production tubing, coiled tubing, or a combination of coiled tubing and annulus between the coiled tubing and casing 124.

At least a portion of fracturing fluid 116 may enter fractures 104 of subterranean formation 122 surrounding wellbore 118 by way of perforations 128. Perforations 127 may extend from the interior of casing 124, through cement sheath 126, and into subterranean formation 122.

Without limitation, well system 100 may be connected to and/or controlled by information handling system 132, which may be disposed on surface 120. Without limitation, information handling system 132 may be disposed on downhole tools (not illustrated) within wellbore 118 during operations. Processing of information recorded may occur down hole and/or on surface 120. Processing occurring downhole may be transmitted to surface 120 to be recorded, observed, and/or further analyzed. Additionally, information recorded on information handling system 132 that may be disposed down hole may be stored until the downhole tool may be brought to surface 120. In examples, information handling system 132 may communicate with fluid handling system 106 through a communication line 134. In examples, wireless communication may be used to transmit information back and forth between information handling system 132 and fluid handling system 106. Information handling system 132 may transmit information to fluid handling system 106 and may receive as well as process information recorded by fluid handling system 106. In examples, a downhole information handling system (not illustrated) may include, without limitation, a microprocessor or other suitable circuitry, for estimating, receiving and processing signals from the downhole tool. Downhole information handling system (not illustrated) may further include additional components, such as memory, input/output devices, interfaces, and the like. In examples, while not illustrated, downhole tool may include one or more additional components, such as analog-to-digital converter, filter and amplifier, among others, that may be used to process the measurements of the downhole tool before they may be transmitted to surface 120. Alternatively, raw measurements from the downhole tool may be transmitted to surface 120.

Any suitable technique may be used for transmitting signals from the downhole tool to surface 120, including, but not limited to, wired pipe telemetry, mud-pulse telemetry, acoustic telemetry, and electromagnetic telemetry. While not illustrated, the downhole tool may include a telemetry subassembly that may transmit telemetry data to surface 120. At surface 120, pressure transducers (not shown) may convert the pressure signal into electrical signals for a digitizer (not illustrated). The digitizer may supply a digital form of the telemetry signals to information handling system 132 via a communication link 134, which may be a wired or wireless link. The telemetry data may be analyzed and processed by information handling system 132.

As illustrated, communication link 134 (which may be wired or wireless, for example) may be provided that may transmit data from the downhole tool to an information handling system 132 at surface 120. Information handling system 132 may include a personal computer 136, a video display 138, a keyboard 140 (i.e., other input devices), and/or non-transitory computer-readable media 142 (e.g., optical disks, magnetic disks) that may store code representative of the methods described herein. In addition to, or in place of processing at surface 120, processing may occur downhole.

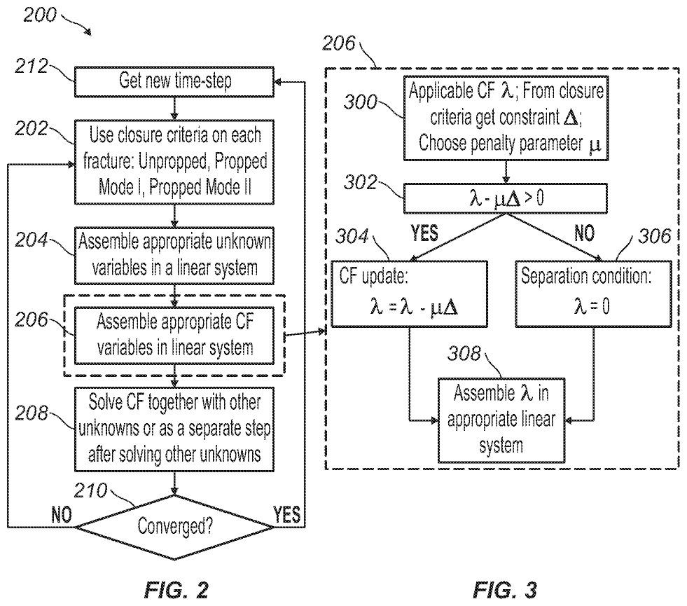

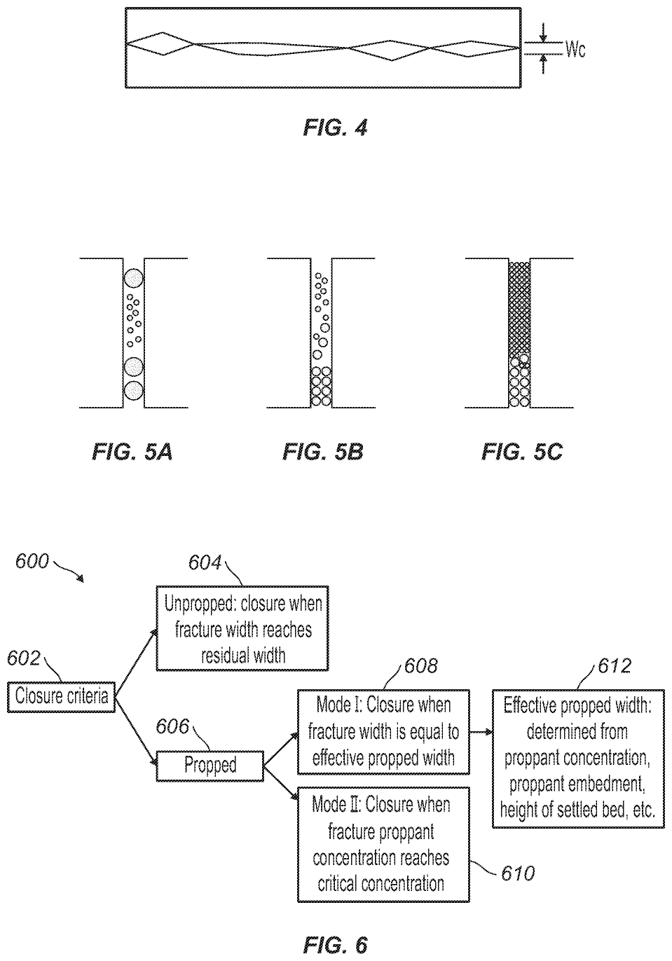

In examples, information handling system 132 (or a different information system) may simulate fracture closures with and without proppant in fracturing operations. Information handling system 132 may be disposed at well site or remote from a well site. Information handling system 132 may simulate well system 100. FIG. 2 illustrates flow chart 200 for determining a fracture closure in a hydraulic fracturing simulator. For first step 202, closure criteria may be applied to different types of fractures which may comprise Unpropped, Propped Mode I, and/or Propped Mode II. In examples, for an unpropped fracture, the closure criterion is a fracture width constraint that equals a residual fracture width of closed fractures (w_{c}). FIG. 4 illustrate residual fracture width of closed fractures (w_{c}). This residual width may be related to the closed, unpropped fracture permeability (k_{c}) that may vary in any given manner (typically as a function of rock stress and fluid pressure inside the fracture) as shown below:

$${k}_{c} = \frac{{w}_{c}^{2}}{12} \qquad ( 1 )$$

In a fracture identified as a Propped Mode I fracture, the closure criteria is also a fracture width constraint but the width equals the effective propped width (wₚ). In examples, wₚ may be determined from the proppant diameter, proppant concentration, proppant bed height, proppant embedment, etc. For example, consider a case of n proppants (FIG. 5(a)) each with diameter Dᵢ and embedment factor uᵢ, where the embedment factor computes the fraction of the width that may be embedded into the rock under the in-situ conditions, wₚ may be determined as shown below:

wₚ=max(αᵢDᵢ) (2)

If there is a settled bed of these proppants (FIG. 5(b)), or a packed bridge of these proppants (FIG. 5(c)) at a current width of w, the below equation may be used:

wₚ=max(αᵢw) (3)

In a fracture identified as a Propped Mode II fracture, the closure criteria may be utilized as a proppant concentration constraint rather than width for situations where we have a packed bridge of proppants (FIG. 5(c)). If ϕ_{c} indicates the packing concentration, then ϕ_{c} may be used as the closure criteria on the total concentration of proppants. It may also possible to switch between Mode I and Mode II constraints to improve convergence.

FIG. 6 illustrates a flow chart 600 for identifying closure criteria 602. For example, an unpropped fracture 604 may be defined as a fracture closure when the fracture width (Referring to FIG. 4), reaches a residual width (wₚ). In examples, a propped fracture 606 may comprise a Mode I fracture 608 and as Mode II fracture 610. Mode I fracture 608 may be defined as a closure when fracture width is equal to effective propped width (wₚ). Effective propped width 612 may be determined from proppant concentration, proppant embedment, height of settle bed, and/or the like. Mode II fracture 610 may be defined as a closure when fracture proppant concentration reaches critical concentration, which is the maximum proppant concentration the fracture may hold. The critical concentration may be determined by proppant shapes and sizes.

Referring back to FIG. 2, after applying closure criterion to selected fracture in step 202, in step 204 information handling system 132, referring to FIG. 1, may assemble appropriate unknown variables in a linear system. In step 206 information handling system 132 may further assemble appropriate contact force variables in the prepared linear system.

FIG. 3 illustrates a flow chart for step 206 to assemble an appropriate contact force variable. In step 300 the applicable contact force between fracture faces may be added as a variable to the simulator. Additional quantities necessary to determine the contract force may include a constraint identified as (Δ) and a penalty parameter identified as (μ). Depending upon the closure criteria used and applicable to a given scenario, there may be a contact force associated with a displacement or width constraint (λ_{d}) and a contact force associated with a proppant concentration constraint (λ_{ϕ}). This method imposes the appropriate displacement and concentration constraints on the simulator, which may lead to a rigorous implementation of closure. The method of obtaining and updating the contact force is shown using (λ_{d}) below, and the method may be similar for obtaining the proppant concentration constraint (λ_{ϕ}). In examples, first the displacement constraint (W) on a fracture using an appropriate closure criteria may be obtained. The displacement solution (w) may be utilized to compute a measure of violation as seen below:

Δ=w−W (4)

then further solving for

$$\begin{matrix} Δ \geq \text{?} \text{?} \geq 0 & ( 5 ) \\ \text{?} \text{indicates text missing or illegible when filed} & \end{matrix}$$

In step 302, λ (which may be either λ_{d} or λ_{ϕ}) may be utilized to determine if the contact force should be updated utilizing the condition below:

λ−μΔ>0 (6)

Where μ is a penalty parameter, for which different values may be used for different constraints. While a constant value for μ may be a common starting assumption, varying μ as some function of Δ may improve convergence behavior for certain problems. The choice of μ may be problem-specific and may require experience with a simulator to appropriately set it. In examples, Δ is a measure of violation (See Equation (4)). If Equation (6) is satisfied, then the contact force may be updated in step 304 as

λ=λ−μΔ (7)

Otherwise, a separation condition may exist in step 306

λ=0 (8)

In step 308, λ may be assembled into the appropriate linear system. Typically in a hydraulic fracturing simulator, variables other than the contact force may be present as unknowns to be solved for at each computational point, at each iteration, as shown in FIG. 2. These variables may be assembled as a linear system of equations identified below:

Ax=b (9)

where x indicates the vector of unknowns, A is the coefficient matrix and b is the right-hand side vector. Furthermore, the contact force λ may be added to this system of equations in step 206.

Once assembled, the variables may be placed back into flow chart 200 (Referring to FIG. 2), where in step 208, the contact force is solved together with all the unknowns or as a separate step after solving for the other unknowns in the simulator. After solving in step 208, it is checked whether the solution may be acceptable. If the underlying problem is linear, then the solution obtained is accepted and proceeds to the next time-step. If the problem is non-linear, guess values may be required to linearize the problem and obtain a solution. Then, the solution may be checked for convergence, which typically involves checking to make sure the obtained solution and the guess values are similar (this is known as convergence of the norm of the variables). In addition, the solution may be substituted in the governing equations to check whether they are satisfied (this is known as convergence of the residue of the governing equations). Each of the steps inside of a time-step may be called an iteration. For linear problems, only one iteration may be needed per time-step. For non-linear problems, a number of iterations may be required. In step 210, if there is a convergence, discussed above, in step 212 the method may proceed to obtain a new time-step and repeat the steps in flow chart 200. If there is not a convergence in step 210, the flow chart repeats itself from step 202, typically using a new time-step or new guess values.

As disclosed herein, information handling system 130 may be used to implement the hydraulic fracturing simulator. Information handling system 130 may perform simulations before, during, and/or after the hydraulic fracturing operation. The hydraulic fracturing operation may be performed based on one or more simulations performed by the information handling system. For example, a pumping schedule or other aspects of the hydraulic fracturing can be generated in advance based on simulations performed by information handling system 130. Additional aspects that may be generated based on simulations may include proppant size, proppant type, and/or proppant characteristics. Such aspects, for example, proppant and proppant size may be simulated for a fracking operation. This may allow an operator to determine and/or select aspects, for example proppant and proppant size, which may be beneficial for the fracking operation. Selected aspects may then be utilized in well system 100. As another example, information handling system 130 may modify, update, or generate a fracture treatment plan based on simulations performed by the information handling system 130 in real time during the hydraulic fracturing operation. In examples, the simulations may be based on logging, completion, and production data obtained from well and surrounding region, as well as real-time observations. For example, real-time observations (or previously observations) may be obtained from pressure meters, flow monitors, microseismic equipment, tilt-meters, or such equipment. Such measurements improve the accuracy with which information handling system 130 may simulate fluid flow. In examples, information handling system 130 may select or modify (e.g., increase or decrease) fluid pressures, fluid densities, fluid compositions, and other control parameters based on data provided by the simulations. In examples, data provided by the simulations may be displayed in real time during the hydraulic fracturing operation, for example, to an engineer or other operator.

This method and system may include any of the various features of the compositions, methods, and system disclosed herein, including one or more of the following statements.

Statement 1: A method for modeling a fracture in a hydraulic fracturing simulator, may comprise simulating a well system with an information handling system, defining a closure criteria for a hydraulic fracturing operation, assembling at least one variable in a linear system, assembling at least one variable of a contact force in the linear system, solving for the contact force, and determining at least one opening or at least one closing of the fracture with the contact force.

Statement 2: The method of statement 1, wherein the assembling at least one variable of the contact force comprises a constraint Δ and a penalty parameter μ.

Statement 3: The method of any preceding claim, wherein an equation λ−μΔ>0 is used to determine if the contact force is updated in an iteration.

Statement 4: The method of any preceding claim, wherein the contact force is updated if an inequality is satisfied.

Statement 5: The method of any preceding claim, wherein the contact force is updated using a second equation λ=λ−μΔ.

Statement 6: The method of any preceding claim, wherein the closure criteria is unpropped, wherein unpropped is fracture closure when the fracture closure width reaches residual width.

Statement 7: The method of any preceding claim, wherein the closure criteria is propped mode-I, wherein propped mode I is the fracture closure when fracture closure width is equal to effective propped width.

Statement 8: The method of any preceding claim, wherein the closure criteria is propped mode II, wherein propped mode II is the fracture closure when a fracture proppant concentration reaches critical concentration.

Statement 9: The method of any preceding claim, further comprising determining if an assembled linear system converges.

Statement 10: The method of any preceding claim, further comprising updating the closure criteria if the assembled linear system does not converge and updating the assembled linear system.

Statement 11: The method of any preceding claim, further comprising identify an opening of the fracture or a closing of the fracture during the simulation.

Statement 12: The method of any preceding claim, further comprising choosing a proppant and adjusting a hydraulic fracturing operation based on the contact force.

Statement 13: The method of any preceding claim, wherein the solving for the contact force further comprises solving for at least one unknown variable, wherein the at least one unknown variable is commonly rock displacement, stresses, pore pressure, fracture height, fluid pressure, or proppant concentration.

Statement 14: A system for modeling a fracture in a hydraulic fracturing simulator may comprise a processor and a memory coupled to the processor. The memory may store a program configured to simulate a well system with an information handling system, define a closure criteria for a hydraulic fracturing operation, assemble at least one variable in a linear system, assemble at least one variable of a contact force in a the linear system, solve for the contact force, and determine at least one opening or at least one closing of the fracture with the contact force.

Statement 15, the system of statement 14, wherein assemble the at least one variable of the contact force comprises a constraint Δ and a penalty parameter μ.

Statement 16, the system of statement 14 or statement 15, wherein an equation λ−μΔ>0 is used to determine if the contact force is updated in an iteration.

Statement 17, the system of statements 14-16, wherein the contact force is updated if an inequality is satisfied.

Statement 18, the system of statements 14-17, wherein the contact force is updated using a second equation λ=λ−μΔ.

Statement 19, the system of statements 14-18, wherein the closure criteria is unpropped, wherein unpropped is the fracture closure when fracture closure width reaches residual width.

Statement 20, the system of statements 14-19, wherein the closure criteria is propped mode I, wherein propped mode I is the fracture closure when fracture closure width is equal to effective propped width.

Statement 21, the system of statements 14-20, wherein the closure criteria is propped mode II, wherein propped mode II is the fracture closure when a fracture proppant concentration reaches critical concentration.

Statement 22, the system of statements 14-21, wherein the program is further configured to determine if an assembled linear system converges.

Statement 23, the system of statements 14-22, wherein the program is further configured to update the closure criteria if the assembled linear system does not converge and updating the assembled linear system.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method for modeling a fracture in a hydraulic fracturing simulator, comprising:
simulating a well system with an information handling system;
defining a closure criteria for a hydraulic fracturing operation;
assembling at least one variable in a linear system;
assembling at least one variable of a contact force in the linear system;
solving for the contact force; and
determining at least one opening or at least one closing of the fracture with the contact force.

2. The method of claim 1, wherein the assembling at least one variable of the contact force comprises a constraint Δ and a penalty parameter μ.

3. The method of claim 2, wherein an equation λ−μ>0 is used to determine if the contact force is updated in an iteration.

4. The method of claim 3, wherein the contact force is updated if an inequality is satisfied.

5. The method of claim 4, wherein the contact force is updated using a second equation λ=λ−μΔ.

6. The method of claim 1, wherein the closure criteria is unpropped, wherein unpropped is fracture closure when the fracture closure width reaches residual width.

7. The method of claim 1, wherein the closure criteria is Propped Mode I, wherein Propped Mode I is the fracture closure when fracture closure width is equal to effective propped width.

8. The method of claim 1, wherein the closure criteria is Propped Mode II, wherein Propped Mode II is the fracture closure when a fracture proppant concentration reaches critical concentration.

9. The method of claim 1, further comprising determining if an assembled linear system converges.

10. The method of claim 9, further comprising updating the closure criteria if the assembled linear system does not converge and updating the assembled linear system.

11. The method of claim 1, further comprising identify an opening of the fracture or a closing of the fracture during the simulation.

12. The method of claim 1, further comprising choosing a proppant and adjusting a hydraulic fracturing operation based on the contact force.

13. The method of claim 1, wherein the solving for the contact force further comprises solving for at least one unknown variable, wherein the at least one unknown variable is commonly rock displacement, stresses, pore pressure, fracture height, fluid pressure, or proppant concentration.

14. A system for modeling a fracture in a hydraulic fracturing simulator, comprising:
a processor; and
a memory coupled to the processor, wherein the memory stores a program configured to:
simulate a well system with an information handling system;
define a closure criteria for a hydraulic fracturing operation;
assemble at least one variable in a linear system;
assemble at least one variable of a contact force in a the linear system;
solve for the contact force; and
determine at least one opening or at least one closing of the fracture with the contact force.

15. The system for modeling a fracture in a hydraulic fracturing simulator of claim 14, wherein assemble the at least one variable of the contact force comprises a constraint Δ and a penalty parameter μ.

16. The system for modeling a fracture in a hydraulic fracturing simulator of claim 15, wherein an equation λ−μΔ>0 is used to determine if the contact force is updated in an iteration.

17. The system for modeling a fracture in a hydraulic fracturing simulator of claim 16, wherein the contact force is updated if an inequality is satisfied.

18. The system for modeling a fracture in a hydraulic fracturing simulator of claim 17, wherein the contact force is updated using a second equation λ=λ−μΔ.

19. The system for modeling a fracture in a hydraulic fracturing simulator of claim 14, wherein the closure criteria is unpropped, wherein unpropped is the fracture closure when fracture closure width reaches residual width.

20. The system for modeling a fracture in a hydraulic fracturing simulator of claim 14, wherein the closure criteria is propped mode I, wherein propped mode I is the fracture closure when fracture closure width is equal to effective propped width.

21. The system for modeling a fracture in a hydraulic fracturing simulator of claim 14, wherein the closure criteria is propped mode II, wherein propped mode II is the fracture closure when a fracture proppant concentration reaches critical concentration.

22. The system for modeling a fracture in a hydraulic fracturing simulator of claim 14, wherein the program is further configured to determine if an assembled linear system converges.

23. The system for modeling a fracture in a hydraulic fracturing simulator of claim 22, wherein the program is further configured to update the closure criteria if the assembled linear system does not converge and updating the assembled linear system.
